(19) United States
(12) Patent Application Publication
(10) Pub. No.: US 2003/0204960 A1
(43) Pub. Date: Nov. 6, 2003

(54) Targeting device

(76) Inventor: Ward William Brien, Chatsworth, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/445,075

(22) Filed: May 23, 2003

Related U.S. Application Data
(63) Continuation-in-part of application No. 09/699,097, filed on Oct. 30, 2000, now Pat. No. 6,568,092.

(51) Int. Cl. G01D 21/00

(52) U.S. Cl. 33/1 PT

(57) ABSTRACT

The invention relates to a targeting device including a casing which houses a wheel. The wheel is weighted and free to rotate relative to the casing. The wheel's absolute orientation remains stable, while the casing rotates with the weapon as it is aimed upward or downward. The casing has a window through which the wheel is visible. For any angle at which the weapon is positioned, a marker inscribed on the wheel aligns with a cosine or distance indicia indicating the cosine of the angle at which the weapon is positioned or the compensated distance to target.

### RELATED APPLICATION

This application is a continuation-in-part of U.S. application Ser. No. 09/699,097, filed Oct. 30, 2000.

### BACKGROUND OF THE INVENTION

The present invention generally relates to targeting devices. More particularly, the present invention relates to a targeting device which assists a user in determining correct target distance which compensates for gravity.

Gravity exerts an earth-bound force on a fired projectile, causing the projectile to depart from its line of fire and strike lower than aimed. Therefore, when a shooter aims at a target, the effect of gravity must be overcome by aiming higher than the actual target. The total effect of gravity in pulling a projectile out of its line of fire is a function of the horizontal, not straight-line, distance from shooter to target. In other words, the farther away horizontally the target, the higher the shooter must aim above the target to compensate for gravity. Most rifles allow the shooter to “zero” the sights based on the distance to target. Thus, the shooter knows the straight-line distance to the target, and sets the sights according to that distance, which results in aiming above the target, thereby compensating for gravity.

This system works well when the shooter and target are at the same elevation because the horizontal distance and the straight-line distance are the same. Therefore, even though a shooter should set his rifle sights according to the horizontal distance to target, and not the straight-line distance, when those two distances are equal, knowing one is as good as knowing the other.

However, if the shooter is required to aim upward or downward to engage his target, setting the sights according to the straight-line distance to target will result in the projectile striking too high. The shooter must calculate the horizontal distance to target to compensate for gravity's effect. Traditionally, a shooter would measure the vertical angle between himself and his target by means of a protractor, calculate the cosine of the angle, multiply the straight-line distance by the cosine to get the horizontal distance, and set his sights according to that distance. This method is time-consuming and requires the shooter to make an accurate trigonometric calculation before firing. This is especially problematic when time is of the essence in sighting, engaging, and firing at the target.

### BRIEF SUMMARY OF THE INVENTION

It is an object of the present invention to provide a small, lightweight device providing a faster, more reliable method for correcting for the gravitational effect when shooter and target are at different elevations. This is accomplished by allowing the shooter to read indicia representing the cosine of the angle or the compensated distance directly without the need to make a trigonometric calculation to compensate for the effects of gravity.

The present invention's casing attaches directly to a weapon scope by means of a mounting apparatus that is part of the casing, and remains fixed with the weapon so that it rotates as the weapon rotates. The casing houses an inner wheel upon which a market or distance indicia is inscribed. The wheel is free to rotate independently of the casing and a stabilizer comprised of a weight keeps the wheel fixed relative to horizontal, while the casing rotates with the weapon as the shooter aims up or down.

A window on the casing allows viewing of the inner wheel, and has indicia comprised of cosine numbers or distance markings or a marker inscribed on it. As the shooter aims the weapon up or down, the indicia rotate relative to the marker, and the indicia aligning directly over the marker represents the cosine of the angle or distance at which the rifle is currently positioned. The shooter can then multiply the straight-line distance to target by the cosine number. This gives the horizontal distance to target, which is the number required for adjusting the rifle's sights before firing.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side elevational view of a targeting device embodying the present invention;

FIG. 2 is a top plan view of the targeting device of the present invention;

FIG. 3 is a side view of the targeting device generally opposite that of FIG. 1;

FIG. 4 is a side elevational view of a wheel of the targeting device having weights therein;

FIG. 5 is a top plan view of the wheel, illustrating a marker thereon;

FIG. 6 is a cross-sectional view of the wheel;

FIG. 7 is a cross-sectional view of the assembled targeting device;

FIG. 8 is a top plan view of a lens having cosine numbers inscribed thereon in accordance with the present invention;

FIG. 9 is a side view of the lens of FIG. 8;

FIG. 10 is an end view of a casing member used in accordance with the present invention;

FIG. 11 is a side and end view of the casing of FIG. 10;

FIG. 12 is cross-sectional view of a casing used in accordance with the present invention;

FIG. 13 is a mount used in accordance with the present invention;

FIG. 14 is a side elevational view of a targeting device embodying the present invention, incorporating distance measuring indicia; and

FIG. 15 is a side elevational view of a wheel of the targeting device, and a window casing exploded therefrom which fits over the wheel in accordance with the present invention.

### DETAILED DESCRIPTION OF THE PREFERRED EMBODIMENTS

The present invention resides in a targeting device for assisting the determination of the distance to the target, and the adjusting of the weapon sight and angle before firing.

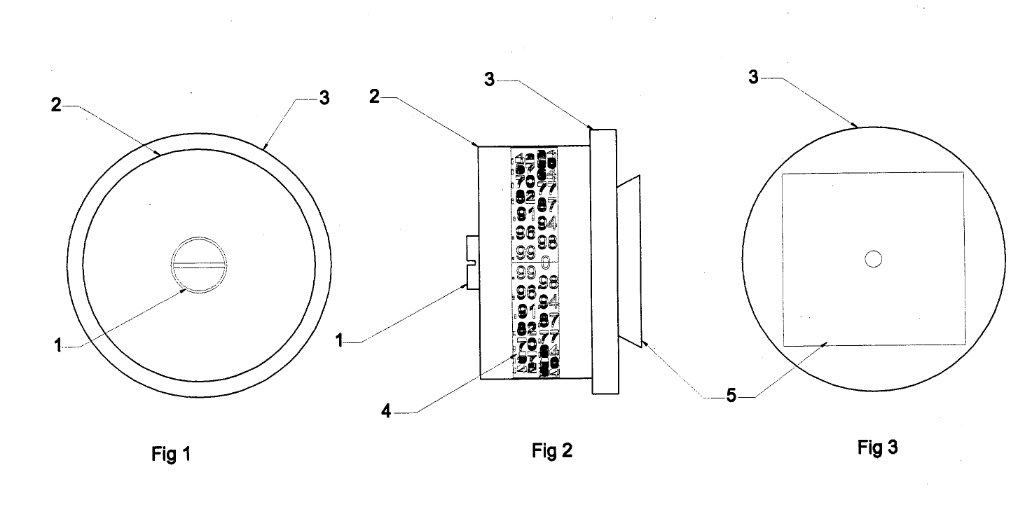

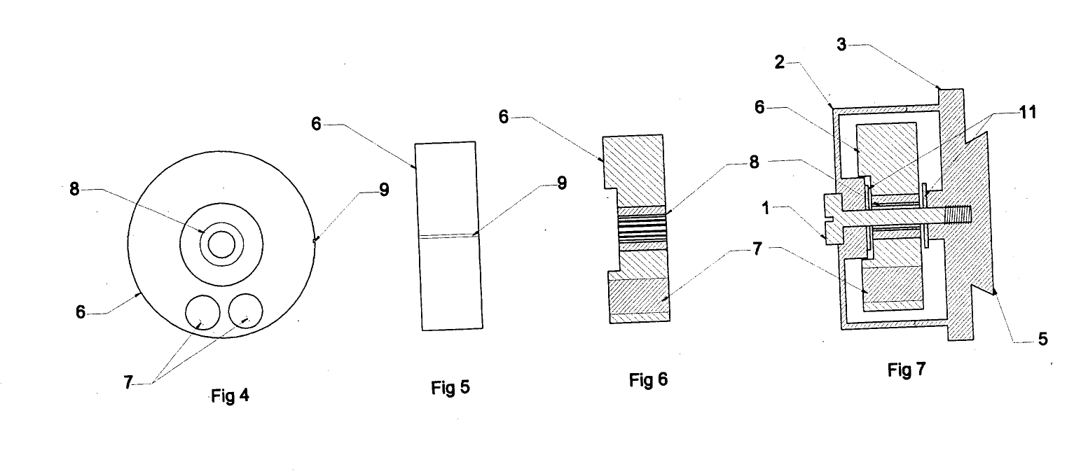

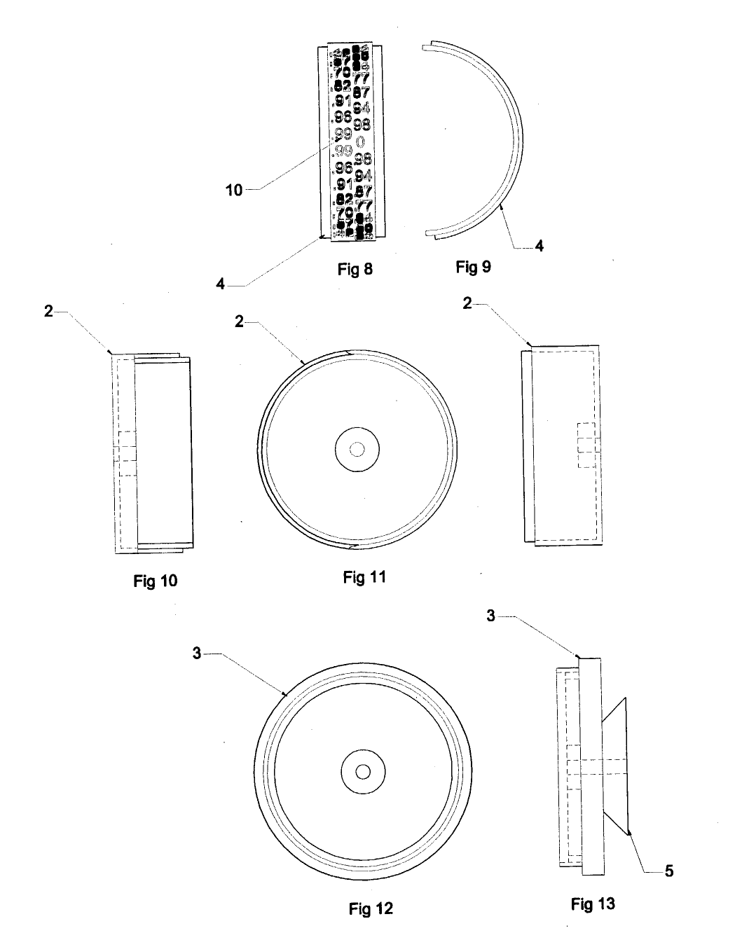

With reference now to FIGS. 1-13, the targeting device is comprised of opposing casing members 2 and 3 housing a wheel 6 which is supported for rotational movement within the casing 2 and 3 by an axle 1. The axle binds the two halves of the casing 2 and 3 together, while allowing the wheel to freely rotate. The axle 1 is typically comprised of a screw or bolt which penetrates the casing sections 2 and 3 through central openings formed therein.

The axle 1 serves as a means of securing the wheel 6 within the casing. A needle bearing 8 fits over the axle 1, and the wheel 6 fits over the needle bearing, thereby allowing the wheel to rotate independently of the axle 1. Two washers 11 are disposed on each side of the wheel 6 and bearing assembly.

The wheel 6 has a weight 7 associated therewith, which keeps the wheels' orientation relative to the earth fixed because of gravity. The weight 7 thus serves as a stabilizer, and the wheel 6 rotates until the stabilizing weight 7 is at the lowest point of gravity. The weight may be embedded in the wheel 6, as illustrated, or otherwise attached to the wheel to maintain an absolute orientation of the wheel 6 relative to gravity.

A window in the casing 2 and 3, of approximately 1600, houses a transparent lens 4. The lense 4 preferably includes cosine numbers 10 inscribed thereon. A marker 9 is inscribed on the surface of the wheel 6, such that as the wheel 6 rotates, the marker 9 aligns itself with a cosine number 10 on the lens 4. This indicates the angle of the rifle from horizontal and permits corrected target distance to be determined. It will be appreciated by those skilled in the art that the cosine numbers 10 can be inscribed on the outer surface of the wheel 6, and the marker 9 inscribed on the lens 4 to achieve the same result. What is important to the invention is that the cosine of the angle of rifle from horizontal be indicated, permitting corrected target distance to be determined.

Preferably, a mount 5 is attached to the casing to allow the targeting device to be mated with the receiving apparatus on a weapon or scope in order to secure the device to the weapon or scope so that it is readily accessible to view the indicated cosign value at the given angle.

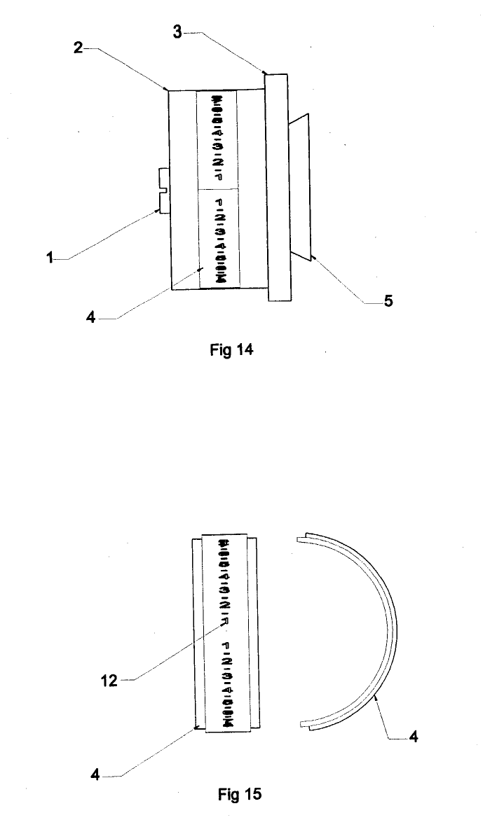

With reference now to FIGS. 14 and 15, another targeting device is illustrated wherein the indicia 12, which may be inscribed on either the wheel 6 or lens 4, comprise direct representation of the distance to target, typically in yards or meters. Thus, the illustrated “1” numerical indicia would represent 100 yards or meters distance to target, compensated for gravity. Alternatively, the numerical indicia could be indicated as “100”. Non-numerical indicia may be used as mid-markers, for example, a dash between the numbers “1” and “2” could represent 150 yards. This embodiment is particularly useful as it completely eliminates the need to perform any trigonomic calculations. The targeting device may be utilized by obtaining the distance to target, aiming at the target and correlating the reading of the indicia with the target, while aiming and then firing at the target.

Thus, as the casing rotates with the weapon as it is aimed upward or downward, the wheels absolute orientation remains stable. This is due to the fact that the wheel is free to rotate about the axle. For any angle in which the rifle is positioned, a marker inscribed on the wheel or lens aligns with a cosign or distance number 10 or 12 inscribed on the window 4 or wheel 6. This number is readable without requiring the shooter to break his cheek weld with the weapon, enabling the shooter to calculate the horizontal distance to the target by multiplying the cosign by a straight-line distance to the target, or reading the number 12.

The targeting device of the present invention can be used with any projectile-firing weapon. It is particularly designed for hunting and sniper rifles. However, the targeting device can be used with other weapons as well. For example, the targeting device of the present invention can be utilized for grenade launcher and mortar applications, such as but not limited to, the M79 40 millimeter grenade launcher, M203A M-16 derivative rifle with 40MM grenade launcher, M224 60 millimeter mortar, M252 and M29A1 81 millimeter mortar, 4.2 inch M30 mortar and the XM120 120 millimeter mortar. By mounting the targeting device onto the weapon or scope, such as onto the rear of the front rail accessory device of the M203A, or by other means, the distance to target is obtained, the shooter takes aim at the target and correlates the reading of the indicia 10 or 12 with the target, while aiming and then firing at the target so that the effects of gravity are compensated.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. A targeting device, comprising:
a casing having a window and attachable to a projectile firing weapon;
an inner wheel rotatably disposed within the casing and viewable through the window;
a stabilizer attached to the wheel for maintaining an absolute orientation of the wheel while the casing is rotated;
indicia formed on the wheel or casing representing the distance to a target; and
a marker attached to the wheel or casing and alignable with the indicia, whereby for any angle at which the weapon is positioned, the marker aligns with specific indicia, indicating gravity compensated distance.

2. The device of claim 1, wherein the window is disposed along the circumferential edge of the casing permitting viewing of the inner wheel from a vantage point on an axis normal to an axis about which the casing rotates.

3. The device of claim 1, wherein the casing includes a mount, mateable with a receiver on the weapon.

4. The device of claim 1, wherein the stabilizer comprises a weight attached to the wheel.

5. The device of claim 1, wherein the indicia include numerals indicating distance in yards or meters.

6. The device of claim 1, wherein the indicia are cosine values corresponding to angles of the weapon from horizontal.

7. The device of claim 1, wherein the indicia are angle values of the rifle from horizontal.

8. The device of claim 1, wherein the window is a transparent section of the outer casing and the indicia is inscribed thereon, and wherein the marker is imprinted onto an outer surface of the wheel, whereby for any angle at which the weapon is positioned, the marker on the wheel aligns with specific indicia on the window.

9. The device of claim 1, wherein the indicia is inscribed upon the wheel and the marker is inscribed upon the casing, whereby for any angle at which the weapon is positioned, the marker on the casing aligns with specific indicia on the wheel.

10. A targeting system, comprising:
a projectile firing weapon;
a casing attached the weapon and including a window;
an inner wheel rotatably disposed within the casing and viewable through the window;
a stabilizer comprised of a weight attached to the wheel for maintaining an absolute orientation of the wheel while the casing is rotated with the weapon;
indicia formed on the wheel or casing representing distance to a target in yards or meters; and
a marker attached to the wheel or casing and alignable with the indicia, whereby for any angle at which the weapon is positioned, the marker aligns with specific indicia, indicating gravity compensated distance.

11. The device of claim 10, wherein the window is disposed along a circumferential edge of the casing permitting viewing of the inner wheel from a vantage point on an axis normal to an axis about which the casing rotates.

12. The device of claim 10, wherein the casing includes a mount mateable with a receiver on the rifle or scope.
